(19) United States
(12) Patent Application Publication
(10) Pub. No.: US 2023/0250021 A1
(43) Pub. Date: Aug. 10, 2023

(54) METHODS FOR RECYCLING USED ENGINE OIL

(71) Applicant: CITY UNIVERSITY OF HONG KONG, Kowloon (HK)

(72) Inventors: Denvid LAU, Kowloon (HK); Huaguo CHEN, Kowloon (HK)

(21) Appl. No.: 18/060,920

(22) Filed: Dec. 1, 2022

Related U.S. Application Data
(60) Provisional application No. 63/304,483, filed on Jan. 28, 2022.

(51) Int. Cl. C04B 18/04; C04B 7/02; C04B 7/42

(52) U.S. Cl. CPC C04B 18/0481; C04B 18/0418; C04B 7/02; C04B 7/42; C04B 2103/0051

(57) ABSTRACT

Disclosed herein are improved methods for recycling used engine oil (UEO). The method includes steps of, mixing UEO, a superplasticizer, and water to give a suspension; mixing aggregates, ordinary Portland cement (OPC), fly ash, silicate fume, and the water to give a first mixture; adding the suspension to the first mixture to give a second mixture; and molding and curing the second mixture into a concrete. The thus produced concrete contains up to 5% of UEO (by weight of total cementitious material) and exhibits comparable compressive properties as to that of ordinary concrete.

### CROSS-REFERENCE TO RELATED APPLICATIONS

This application claims priority and the benefit of U.S. Provisional Patent Application No. 63/304,483, filed Jan. 28, 2022, entitled, “Method for Recycling Used Engine Oil Using Concrete”, the entirety of which is incorporated herein by reference.

### BACKGROUND OF THE INVENTION

### 1. Field of the Invention

The present invention relates to a process of recycling used engine oil (UEO). Specifically, the present invention relates to recycling UEO by incorporating the UEO into a concrete mix with the aid of a superplasticizer (SP).

### 2. Description of Related Art

The growing concern for environmental protection prompts the search for an improved process for recycling UEO. UEO is among the wastes of interest, approximately 40 billion kilograms of UEOs are generated annually through transport and industrial activities worldwide (Zhang et al., 2017 J. Hazard. Mater. 332, 51-58.). Incineration and chemical treatment are two commonly adopted approaches for the disposal of such large quantities of UEO. However, these two solutions require high operation costs and cause high-level carbon dioxide emissions, since they utilize a considerable quantity of power-consuming equipment. To avoid these high costs, it has been reported that approximately 55% of worldwide UEO is directly dumped into landfills or waterways (Sam et al., 2020 J. Clean. Prod. 258, 120937.), as this method treats UEO as a type of municipal solid waste and the processing cost is relatively low. Despite its low cost, landfilling aggravates groundwater and land contamination, and hence it is now illegal.

The utilization of waste into concrete has been proposed as a clean means for disposal of waste, as such an approach effectively minimizes greenhouse emissions and results in considerable savings by avoiding the high processing costs of current disposal options. Previous studies have presented great potential uses for waste in cementitious materials, such as plastic waste, sludge waste, açaí natural fiber, glass waste, used engine oil (UEO), and etc. Specifically, the use of recycled plastic improves the thermal properties of cementitious materials due to its low thermal conductivity (da Silva et al., 2021 Materials. 14(13), 3549.). The incorporation of primary sludge waste from the pulp and paper industry into mortars enhances mechanical strength because of its pozzolanic activity (de Azevedo et al., 2020. J. Clean. Prod. 249, 119336.). Treated açaí natural fiber aids in strengthening cement-based mortars owing to its filling effect (Marvila et al., 2020 Case Stud. Constr. Mater. 13, e00406.). Recycling glass waste as a partial replacement for cement and fine aggregate is beneficial for obtaining better fluidity features in cement mortars (de Azevedo et al., 2017 Construct. Build. 148, 359-368.). It can clearly be seen that adding waste into concrete can not only bring about environmental and economic benefits but also improve the technological and durability performance of cementitious materials.

Previous works suggest that low dosages of UEO can be incorporated into concrete, however, only a limited amount of UEO can currently be introduced into concrete as poor dispersion of UEO in the cement mixture adversely affects cement hydration. Previous studies have shown that the optimum dosage of UEO by weight of cement is limited to approximately 0.3-0.5% (Assaad, 2013. Construct. Build. Mater. 44, 734-742). Accordingly, there exists in the related field a need for an improved design of a concrete mix, which could incorporate a high dosage of UEO, preferably, more than 0.5% UEO as reported in the existing approach, without sacrificing the workability and/or compressive properties of the concrete mix.

### SUMMARY

Embodiments of the present disclosure relate to methods for recycling UEO by incorporating UEO into a concrete mix. The thus produced concrete mix not only can incorporate a high dosage of UEO, but also produce a concrete with improved compressive strength.

Accordingly, the first objective of the present disclosure therefore is to provide a method of recycling UEO. The method includes,
(a) mixing the UEO, a superplasticizer, and water to give a suspension;
(b) mixing aggregates, ordinary Portland cement (OPC), fly ash, silicate fume, and the water to give a first mixture;
(c) adding the suspension of step (a) to the first mixture of step (b) to give a second mixture; and
(d) molding and curing the second mixture of step (c) into a concrete,
wherein, in the second mixture,
   the UEO is present in about 1-5% by weight of total cementitious material;
   the superplasticizer is present in about 0.1-5% by weight of total cementitious material;
   the OPC, the fly ash, and the silicate fume are present in about 10-30% by weight of total cementitious material; and
   the water is present in about 20-60% by weight total cementitious material.

According to embodiments of the present disclosure, the superplasticizer has a hydrophilic-lipophilic balance (HLB) value between 17 and 13.6.

Examples of the superplasticizer suitable for use in the present method include, but are not limited to, a sulfonated naphthalene formaldehyde condensate, a sulfonated melamine formaldehyde condensate, an acetone formaldehyde condensate and polycarboxylated ethers. Preferably, the superplasticizer is the sulfonated naphthalene formaldehyde condensate.

According to embodiments of the present disclosure, in step (a), the suspension is stirred at a speed of 900 rpm for 30 min.

According to embodiments of the present disclosure, in step (b), the aggregates comprise coarse aggregates and fine aggregates, respectively about 20 mm and 10 mm in diameter.

According to embodiments of the present disclosure, the coarse aggregates and the fine aggregates are present in the ratio of 1:1.6 by weight in the aggregates.

According to embodiments of the present disclosure, in step (b), the OPC, the fly ash, and the silicate fume are present in the ratio of 75:20:5.

According to preferred embodiments of the present disclosure, the UEO and the SP are respectively present in about 1%-5% and 0.1%-5%, respectively, by weight of total cementitious material in the second mixture.

Other and further embodiments of the present disclosure are described in more detail below.

### BRIEF DESCRIPTION OF THE DRAWINGS

The disclosure will become more fully understood from the detailed description and the drawings given herein below for illustration only, and thus does not limit the disclosure, wherein:

FIG. 1 shows a process in flowchart form embodying features of an embodiment of the present disclosure;

FIG. 2(a)-2(b): Compressive strength of normal strength concrete as a function of the dosage level of added UEO and its changes compared with the control groups. 2(a) Compressive strength of C45 concrete with and without SCMs. 2(b) Variations in compressive strength at C45 concrete mixes (error bars show one standard deviation). In the equation, fᵢ stands for compressive strength of concrete containing varying dosages of UEO, and f_{R} denotes that of concrete made without UEO. The variation (Δ_{f}) was calculated as the average ratio of (fᵢ−f_{R}) over f_{R}, multiplied by 100;

FIG. 3(a)-3(b): Compressive strength of high strength concrete and its changes compared with the control groups. 3(a) Compressive strength of C60 and C80 concrete. 3(b) Variations in compressive strength at C60 and C80 concrete mixes; and

FIG. 4(a)-4(h): Morphological changes of the surface of concrete without and with UEO incorporated. 4(a), 4(b) and 4(c) show the SEM images of C45, C60, and C80 triple blending concrete containing 2% UEO by weight of cementitious materials, correspondingly, in which microstructures of concrete featuring few cracks and voids were observed. 4(d), 4(e) and 4(f) present the SEM images of C45, C60, and C80 triple blending concrete without UEO, respectively, in which a significant number of micro porosities and cracks were visible. 4(g) A dense ITZ formed in concrete with UEO. 4(h) Filler effect of SCMs and the pozzolanic reactions between calcium hydroxide and SCMs.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

The present disclosure provides a novel process for recycling used engine oil (UEO). Particularly, embodiments of the present disclosure include improved methods of recycling UEO in novel concrete design mix, in which a superplasticizer is employed to achieve good dispersion of UEO in ternary blended concrete with fly ash and silica fume. Methods in accordance with embodiments of the present disclosure are advantageously simple, and easy-to-use, and the thus produced ternary blended concrete (i.e., concrete article) containing a high dosage of UEO exhibits comparable workability and compressive properties as that of ordinary concrete.

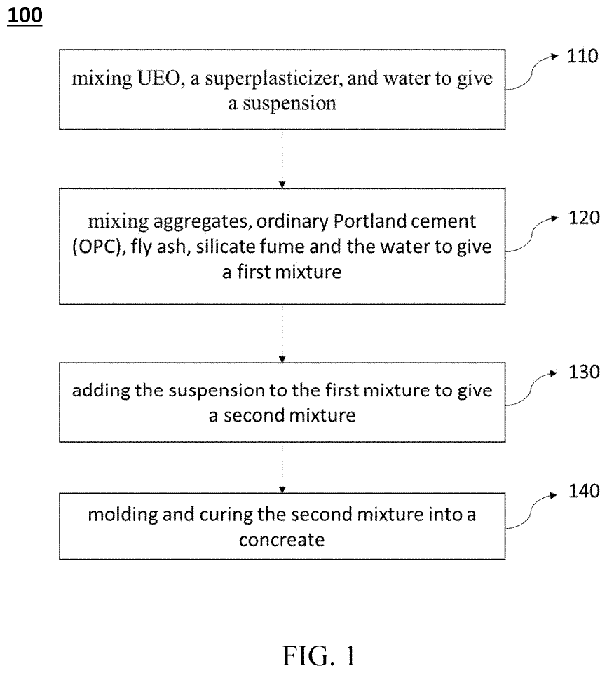

The first aspect of the present disclosure is to provide a method of recycling UEO. FIG. 1 depicts a process 100 in flowchart form embodying features of the present invention comprises steps of mixing UEO, a superplasticizer, and water to give a homogeneous suspension (step 110); mixing aggregates, ordinary Portland cement (OPC), fly ash, silicate fume, and the water to give a first mixture (step 120); adding the suspension of step 110 to the first mixture of step 120 to give a second mixture (step 130); and molding and curing the second mixture of step 130 into a concrete (step 140).

As shown in FIG. 1, the present process 100 commences by mixing and stirring UEO, a superplasticizer, and water in a container for a sufficient period until a homogeneous suspension is formed (step 110). Preferably, the UEO, the superplasticizer, and the water are stirred at a low speed of about 900 rpm for at least 30 minutes.

According to embodiments of the present disclosure, UEO suitable for being recycled by the present process 100 may be any synthetic or semisynthetic engine or lubricating oil that has been used for at least 6 months, such as 6, 7, 8, 9, 10, 11, and 12 months. In preferred embodiments of the present disclosure, the UEO was multi-grade and semisynthetic engine oil that had been used for 6 months, with a density of 0.848 g/cm³.

To help disperse UEO in concrete, superplasticizers (SPs), also known as high-range water reducing admixture (HRWRA), are mixed with UEO and water prior to mixing with materials forming a cement mixture in subsequent steps. SPs have a dual function, one is to act as a surfactant to attain well-dispersed water-oil mixtures, and the other is to improve the workability of fresh concrete. The efficacy of an SP is correlated to its Hydrophilic-Lipophilic Balance (HLB) value. A high HLB value results in a better dispersion ability on the part of the superplasticizer and well-dispersed oil-in-water emulsion. According to embodiments of the present disclosure, the SP suitable for use in the present process has the HLB value between 13.6 and 17, such as 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, or 17.0. Examples of the SP suitable for use in the present method include, but are not limited to, a sulfonated naphthalene formaldehyde condensate, a sulfonated melamine formaldehyde condensate, an acetone formaldehyde condensate and polycarboxylated ethers. Preferably, the SP is the sulfonated naphthalene formaldehyde condensate having the HLB value approaches 17.0.

In step 120, aggregates, ordinary Portland cement (OPC), fly ash, silicate fume, and water are mixed in a concrete mixer to give a first mixture. Concrete is a composite material composed of fine and coarse aggregates bonded together with cementitious materials (e.g., OPC) that hardens over time, Aggregates suitable for use in the present process are fine and coarse aggregates that are about 10 mm and 20 mm in diameter, respectively. According to preferred embodiments of the present disclosure, the fine and coarse aggregates are present in the ratio of about 1.6:1 by weight in the first mixture. OPC is the most common type of cement in general use around the world as a basic ingredient of concrete. According to preferred embodiments of the present disclosure, the OPC, the fly ash, and the silicate fume are present in the ratio of 75:20:5.

In step 130, the suspension of step 110 is transferred to the first mixture of step 120 (or the cement mixture) to give a second mixture (or a cement mixture). The second mixture, or the cement mixture, is then poured into a mold and let harden (cure) over time, thereby forming a concrete (step 140), which is then subjected to scanning electron microscopy (SEM) analysis and mechanical strength test.

According to embodiments of the present disclosure, in the cement mixture of steps 130 or 140, the UEO is present in about 1-5% by weight of the total cementitious material, such as 1, 2, 3, 4, and 5% by weight of the total cementitious material, preferably, the UEO is present in about 2% by weight of the total cementitious material. According to preferred embodiments of the present disclosure, the concrete formed by the cement mixture containing 2% (wt. %) UEO exhibits the maximum improvement in compressive strength by 4.4%.

According to embodiments of the present disclosure, in the cement mixture of steps 130 or 140, the SP is present in about 0.1-5% by weight of total cementitious material, such as 0.1, 0.2, 0.3, 0.4, 0.5, 0.6, 0.7, 0.8, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, and 5.0% by weight of the total cementitious material; preferably, the SP is present in about 2% by weight of the total cementitious material.

According to embodiments of the present disclosure, in the cement mixture of steps 130 or 140, the fly ash and the silicate fume are present in about 10-30% by weight of total cementitious material, such as 10, 11, 12, 13, 14, 15, 16, 17, 18, 19, 20, 21, 22, 23, 24, 25, 26, 27, 28, 29, and 30% by weight of total cementitious material, preferably, the fly ash and the silicate fume are present in about 20% and 5% by weight of total cementitious material, respectively.

According to preferred embodiments of the present disclosure, in the cement mixture of steps 130 or 140, the water is present in about 20-60% by weight of total cementitious material, such as 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, and 60% by weight of total cementitious material; preferably, the water is present in about 60% by weight of total cementitious material.

According to embodiments of the present disclosure, the thus produced concrete exhibits denser microstructures and comparable compressive properties as that of concrete made of ordinary cement material (i.e., the concrete made of ordinary cement material without the addition of SP and UEO).

Throughout the description and claims, “comprising” and “including” are interchangeably used, and are not intended to exclude other technical features, additives, components, and steps. Additional objects, advantages, and features of the invention will become apparent to those skilled in the art upon examination of the description or may be learned by practice of the invention.

### Examples

The following examples are provided by way of illustration and are not intended to be limiting to the present invention.

Materials and Method

Materials and Preparation

ASTM Type I ordinary Portland cement (OPC), fly ash, silicate fume, UEO, superplasticizer, tap water, and locally available fine, and coarse aggregates were used as basic ingredients to manufacture concrete. The OPC was retrieved from Green Island Cement (Holdings) Limited in Hong Kong, while the fly ash and silica fume, which met the requirements of ASTM C618 and ASTM C1240, were supplied by Henan Borun Casting Material Co., Ltd. In accordance with ACI 211.4R, the fly ash and silica fume were used more as a partial replacement for cement rather than as an additive to the concrete mixtures.

The admixed UEO was the used multi-grade and semisynthetic engine oil of Delo® Gold Ultra SAE 15 W-40 from Chevron Corporation. This oil is a high-performance, multigrade, and heavy-duty diesel engine oil specifically designed to lubricate a wide range of engines. The UEO, which had been used for half a year, with a density of 0.848 g/cm³, was collected from an engine-driven generator (Yaphary et al., 2020. Construct. Build. Mater. 261, 119967.). The main chemical compounds of UEO are dominated by low molecular weight alkylbenzene and alkanes ranging from C₉H₁₈ to C₁₂H₂₄ with a maximum peak area at C₁₂H₂₄ (Liu et al., 2018. Construct. Build. Mater. 191, 1210-1220.). Eight varying UEO contents, i.e., 0, 0.5%, 1%, 2%, 3%, 4%, 5% and 6% of cementitious materials mass, were admixed into concrete in order to study how these contents affected the performances of concrete. To reveal the effect of an overdose of UEO, a high dosage of 6% was also selected.

In this study, Grace Construction Products (GCP) Daracem® 108 high-range water-reducing admixture (HRWRA) from GCP Applied Technologies Incorporation, an aqueous solution of naphthalene-based dispersants, was used as a surfactant to disperse the UEO and cement particles. As per ACI 212.4R, high-range water-reducing admixtures should be used in accordance with the manufacturer's recommended dosage range. The dosage of Daracem® 108 at between 400 and 1800 mL per 100 kg of cementitious materials was decided according to the recommendation. The maximum dosage was 1,800 mL/100 kg of cementitious materials, approximately 2% of cementitious materials. A dosage of 2% HRWRA by weight of cementitious materials was added into the concrete mix in order to disperse the UEO as much as possible and enhance the workability of the concrete.

### Example 1: Preparation and Characterization of Concrete Containing UEO

1.1 Design of Concrete Mixtures Containing UEO

Three concrete grades, i.e., C45, C60, and C80, were investigated in this study in order to evaluate the effect of UEO on the performance of the concrete typically used in the construction industry. Among these grades, C45 and C80 concrete represent normal strength and high strength concrete, respectively. C60 is also a high strength concrete that can bridge C45 and C80 concrete grades; these three grades were expected to yield a trend. Since the replacement of OPC with supplementary cementitious materials (SCMs, e.g., fly ash and silica fume) is a widely adopted strategy for improved durability and strength of high strength concrete, the OPC in C60 and C80 was partially replaced by SCMs. In addition, two C45 concrete mixtures with and without SCMs could provide a fair comparison regarding whether the addition of the SCMs was effective. In total, four concrete design mixes were used.

Based on the above selection and the study aim, there were three main variables in this experiment: UEO dosage levels, concrete mixes, and the replacement of cement with SCMs. Error! Reference source not found. 2 shows the ratio and nomenclature of the concrete's constituent materials with UEO. The nomenclature of each of the concrete specimens was provided in the format of its variables (written in capital letters) and their respective values (designed as x), i.e., Cx-Sx-Ux. The meaning denoted by each symbol is as follows: Cx represents concrete grades, Sx stands for the percentage of OPC replaced with fly ash and silica fume, and Ux refers to the percentage of UEO by weight of cementitious materials incorporated into the concrete design mix. The designations with no UEO addition were considered the control specimens (C45-S0-U0, C45-S25-U0, C60-S25-U0, and C80-S25-U0).

TABLE 1
Ratio and nomenclature of concrete constituent materials with UEO in relation to mass.

| | | | | | 20 mm/ | 10 mm/ | | |
|---|---|---|---|---|---|---|---|---|
| | | | Silica | River | Coarse | Coarse | | |
| Nomenclature | Cement | Fly Ash | fume | sand | aggregate | aggregate | Water | UEO |
| C45-S0-U0 | 1.000 | 0 | 0 | 1.907 | 1.209 | 0.977 | 0.384 | 0 |
| C45-S0-U0.5 | | | | | | | | 0.005 |
| C45-S0-U1 | | | | | | | | 0.010 |
| C45-S0-U2 | | | | | | | | 0.020 |
| C45-S0-U3 | | | | | | | | 0.030 |
| C45-S0-U4 | | | | | | | | 0.040 |
| C45-S0-U5 | | | | | | | | 0.050 |
| C45-S0-U6 | | | | | | | | 0.060 |
| C45-S25-U0 | 0.750 | 0.200 | 0.050 | 1.907 | 1.209 | 0.977 | 0.384 | 0 |
| C45-S25-U0.5 | | | | | | | | 0.005 |
| C45-S25-U1 | | | | | | | | 0.010 |
| C45-S25-U2 | | | | | | | | 0.020 |
| C45-S25-U3 | | | | | | | | 0.030 |
| C45-S25-U4 | | | | | | | | 0.040 |
| C45-S25-U5 | | | | | | | | 0.050 |
| C45-S25-U6 | | | | | | | | 0.060 |
| C60-S25-U0 | 0.750 | 0.200 | 0.050 | 1.426 | 1.050 | 0.851 | 0.327 | 0 |
| C60-S25-U0.5 | | | | | | | | 0.005 |
| C60-S25-U1 | | | | | | | | 0.010 |
| C60-S25-U2 | | | | | | | | 0.020 |
| C60-S25-U3 | | | | | | | | 0.030 |
| C60-S25-U4 | | | | | | | | 0.040 |
| C60-S25-U5 | | | | | | | | 0.050 |
| C60-S25-U6 | | | | | | | | 0.060 |
| C80-S25-U0 | 0.750 | 0.200 | 0.050 | 1.383 | 0.991 | 0.804 | 0.280 | 0 |
| C80-S25-U0.5 | | | | | | | | 0.005 |
| C80-S25-U1 | | | | | | | | 0.010 |
| C80-S25-U2 | | | | | | | | 0.020 |
| C80-S25-U3 | | | | | | | | 0.030 |
| C80-S25-U4 | | | | | | | | 0.040 |
| C80-S25-U5 | | | | | | | | 0.050 |
| C80-S25-U6 | | | | | | | | 0.060 |

*The cementitious materials included cement, fly ash, and silica fume. All the water in the chemical admixtures was chemically bonded to the products and was not available to increase the water to cementitious materials ratio (w/cm), which is why its volume was not deducted from the mixing water of the concrete. All admixture dosages shown are by weight of cementitious materials. The dosage level of the superplasticizer used in each mix is 2%.

1.2 Preparation of concrete mixtures and specimens

In total, 96 concrete specimens were manufactured for compressive tests (96=4 mixes×8 UEO concentrations×3 specimens for repeatability). 32 fresh concrete mixtures were prepared for slump tests (32=4 mixes×8 UEO concentrations). Initially, the suspension was stirred at 900 rpm for 30 minutes with a magnetic stirrer in order to obtain well-mixed admixtures of UEO, superplasticizer, and a portion of water with a mass equalling that of the UEO. This suspension was then poured into a running concrete mixer where the aggregates, cement, and remaining water had already been mixed for three minutes. An additional two minutes was spent mixing the concrete mixture with the suspension. The fresh concrete was then dumped into cylindrical moulds with a size of 100 mm×200 mm and compacted in a vibration machine in order to achieve full compaction with neither segregation nor excessive laitance. They were demoulded a day after casting and cured in a fog room (20±2° C., 95% relative humidity) for 28 days. All mixing was conducted under laboratory conditions.

1.3 Test setup and methods

Freshly prepared mixtures of water, superplasticizer, and oil were analyzed using an electron microscope (Olympus BX61), interfacing with a digital imagining solution at room temperature in order to observe UEO dispersion. Initially, a drop of the prepared mixture was placed onto the center of a microscopic glass slide using a pipette. A coverslip was then carefully placed to minimize destruction of the mixture structures and to avoid air bubbles. The well-prepared microscopic slides were placed under the microscope in order to view the UEO dispersion.

Immediately after the completion of the mixing, the fresh concrete mixtures were sampled in order to determine slump value. A sample of newly mixed concrete was placed and compacted by rodding in a mold shaped as a slump cone, conforming to ASTM C 143/C 143M (ASTM C143/C143M, 2012). The mold was raised, and the concrete was allowed to subside. The vertical distance between the original and displaced position of the center of the top surface of the concrete was measured and reported as the slump of the concrete.

Cylindrical specimens with a size of 100 mm×200 mm were prepared to determine the compressive strength of UEO concrete. The measurement was performed using the Material Test System (MTS) machine with a maximum compressive load of 3000 kN and in displacement control mode with a rate of 0.5 mm/min as per ASTM standard (ASTM C39/C39M, 2010). The averages of three specimens were calculated to obtain the compressive strength.

The SEM analysis of concrete containing UEO was obtained with a Su8010 scanning electron microscope, supplied by Hitachi Ltd. After compressive tests, the broken pieces of concrete specimens were collected in order to prepare the SEM samples. The samples were immersed in isopropanol for 24 hours to prevent further cement hydration, and then dried in a vacuum pump to remove any evaporable moisture at 55° C. for three days. The samples were treated with golden sputtering before SEM analysis in order to obtain high resolution images.

1.3.1 Slump Test Results

The effects of various UEO contents on workability levels of different fresh concrete mixes are shown in Table 2. Slump values of various concrete mixes with increasing UEO dosage levels at the fresh state.

| UEO content | Slump value (mm) | | | |
|---|---|---|---|---|
| (% by weight of | C45 without | C45 with | | |
| cementitious materials) | SCMs^{a} | SCMs | C60 | C80 |
| 0 | 170 | 210 | 240 | 225 |
| 0.5 | 173 | 220 | 245 | 228 |
| 1 | 175 | 225 | 246 | 236 |
| 2 | 200 | 228 | 232 | 223 |
| 3 | 205 | 228 | 230 | 222 |
| 4 | 213 | 229 | 229 | 220 |
| 5 | 220 | 229 | 227 | 218 |
| 6 | 221 | 233 | 225 | 216 |

^{a}The letters SCMs denote supplementary cementitious materials, including fly ash and silica fume.

2. All the concrete admixed with SCMs presented very high workability levels in the range of 210 mm to 250 mm. No segregation, bleeding, or sedimentation were observed in any of the concrete mixes during the concrete manufacturing process. The slump test results for the C60 and C80 concrete that incorporated various amounts of UEO exhibited a similar trend. The workability of this freshly made concrete showed an increasing trend with increasing dosage of UEO up to 1%, beyond which the overdosing UEO led to a reduction in the slump value. Notwithstanding the slight decrease, the workability of these concrete mixes was comparable to that of the control mixes. These results suggest there is a threshold for inclusion levels of UEO in high strength concrete mixes, beyond which its water-reducing effect will be adversely affected. However, the slump value in all of the C45 concrete mixes remained on an upward trend after increasing the UEO dosage levels from 1% to 6%. Among the C45 concrete mixes, a more significant growth in slump value was visible in the C45 concrete mixed with SCMs compared to that of the C45 concrete containing no SCMs. The comparison of C45 concrete mixes with and without SCMs showed that the combination of superplasticizer and SCMs significantly helped to enhance the slump levels of UEO concrete. The incorporation of SCMs can ameliorate the workability of C45 concrete mixes due to the ball-bearing effect, which helps the lubrication between particles in concrete. It should be noted that this improvement became slight with the increasing UEO contents in the C45 concrete mixes. In light of the above results regarding the slump value, it can be concluded that the optimum dosages of UEO are 1% and at least 6% in high-strength and normal-strength concrete, respectively. The increase in the optimal dosage of UEO in this study is more than seven times that reported in former studies, where the workability of concrete reduced when the dosage of UEO increased to 0.3-0.5% (Assaad, 2013 Construct. Build. Mater. 44, 734-742; Yaphary et al., 2020, Construct. Build. Mater. 261, 119967). These significant enhancements indicate that SCMs and superplasticizers are effective in terms of the workability of concrete.

TABLE 2
Slump values of various concrete mixes with increasing
UEO dosage levels at the fresh state.

| UEO content | Slump value (mm) | | | |
|---|---|---|---|---|
| (% by weight of | C45 without | C45 with | | |
| cementitious materials) | SCMs^{a} | SCMs | C60 | C80 |
| 0 | 170 | 210 | 240 | 225 |
| 0.5 | 173 | 220 | 245 | 228 |
| 1 | 175 | 225 | 246 | 236 |
| 2 | 200 | 228 | 232 | 223 |
| 3 | 205 | 228 | 230 | 222 |
| 4 | 213 | 229 | 229 | 220 |
| 5 | 220 | 229 | 227 | 218 |
| 6 | 221 | 233 | 225 | 216 |

^{a}The letters SCMs denote supplementary cementitious materials, including fly ash and silica fume.

1.3.2 Compression Test Results

Two distinct failure patterns, i.e., conic fragments and shear band, for the concrete admixed with UEO were used as indicators of compression test results. All failure modes of concrete containing UEO that occurred are well established as the typical failure modes of normal concrete according to ASTM C39 (ASTM C39/C39M, 2010). Similarly to normal concrete without UEO, the concrete specimens of Example 1.2 also exhibited failure patterns of either cone or shear and cone. The cone mode of failure generated conic fragments in the top and bottom (data not shown). For a shear and cone failure, a main inclined fracture surface was nucleated in cylinders, and a conic fragment formed (data not shown). These two typical fracture types were related to the constraint of the platens in the testing machine. This restraint confined the cylindrical concrete specimens in the vicinity of the platens and resulted in one or two relatively undamaged cones. It was observed that before the applied loading approached the peak value, no visible cracks occurred at the concrete surface. After that, many vertical and inclined cracks spread with the increasing compressive load. The lateral sides were spalled, and there was fragmentation due to crushing.

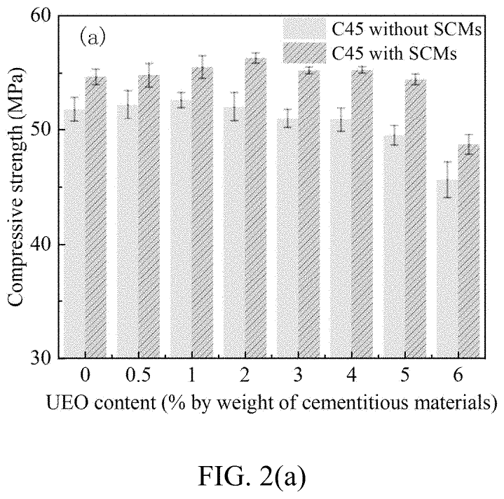

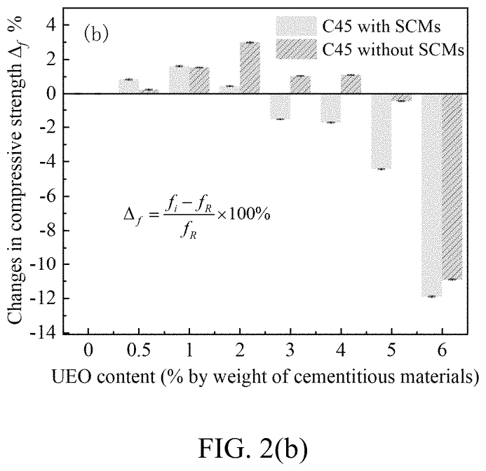

FIG. 2 shows the compressive strength of C45 concrete containing different UEO contents and their variations in compressive strength compared with the control samples. The favorable effect of SCMs on the compressive strength of C45 concrete with UEO can be seen in FIG. 2(a). These data indicated that the substitution of cement with fly ash and silica fume aided in the strength development of concrete containing UEO. Furthermore, when it comes to the effect of UEO, the greatest improvement in concrete strength was observed for triple bending C45 concrete containing 2% UEO. The compressive strength of C45 concrete containing up to 5% UEO concentrations was still comparable to that of the reference concrete, with only a 0.43% reduction in the compressive strength. Unlike triple bending C45 concrete, the maximum dosage of UEO that can be introduced into plain cement concrete without deterioration in the strength properties is 2%. This UEO incorporation level was 2.5 times lower than that of triple bending C45 concrete. The alterations in compressive strength of C45 concrete mixes incorporating UEO are presented in FIG. 2(b). It can be seen that the compressive strength of C45 concrete increased by about 2.99% when a 2% UEO was added. However, the strength of C45 concrete containing the same dosage level of UEO only reached approximately 0.45% without the aid of SCMs. In this plain cement concrete, it should be noted that 11.9% of the compressive strength was lost when a 6% dosage of UEO was added.

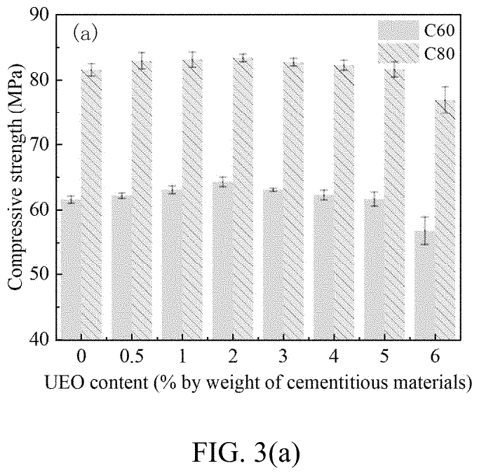

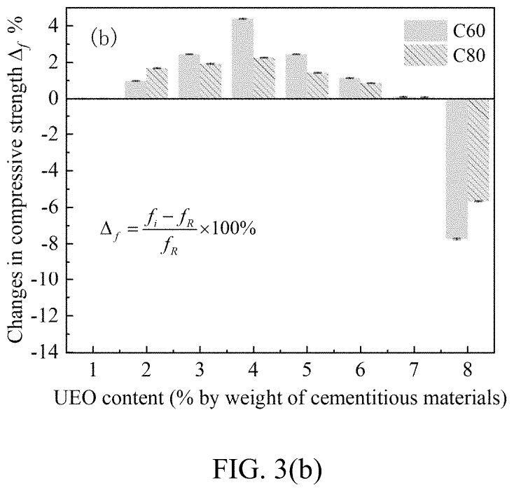

The effect of various UEO concentrations on the compressive strength in high strength concrete and its changes are plotted in FIGS. 3(a)-3(b). As shown in FIG. 3(a), high strength concrete admixed with 2% exhibited the highest value of compressive strength. Interestingly, the compressive strength increases from 61.6 MPa to 64.3 MPa and 81.3 MPa to 83.4 MPa in C60 and C80 concrete, respectively, with increasing UEO addition levels from 0% to 2%, before dropping down to 61.6 MPa and 81.6 MPa for 5%, correspondingly. Despite the reduction, the compressive strength of concrete with an added 5% UEO level was still comparable with that of the controls. As can be seen from FIG. 3(b), the maximum growth in compressive strength reaches approximately 4.4% in C60 concrete admixed with 2% UEO. When the incorporation levels of UEO reach 6%, there was a dramatic drop in the compressive strength of high strength concrete: approximate reductions of 8% and 6% in C60 and C80 concrete, respectively. These compression test results indicated that the proposed solution for incorporating a high dosage level of UEO was effective. The dosage level of UEO used in the present study was approximately ten times higher than previous studies using 0.3% (Assaad, 2013, Construct. Build. Mater. 44, 734-742).

1.3.3 SEM Analysis

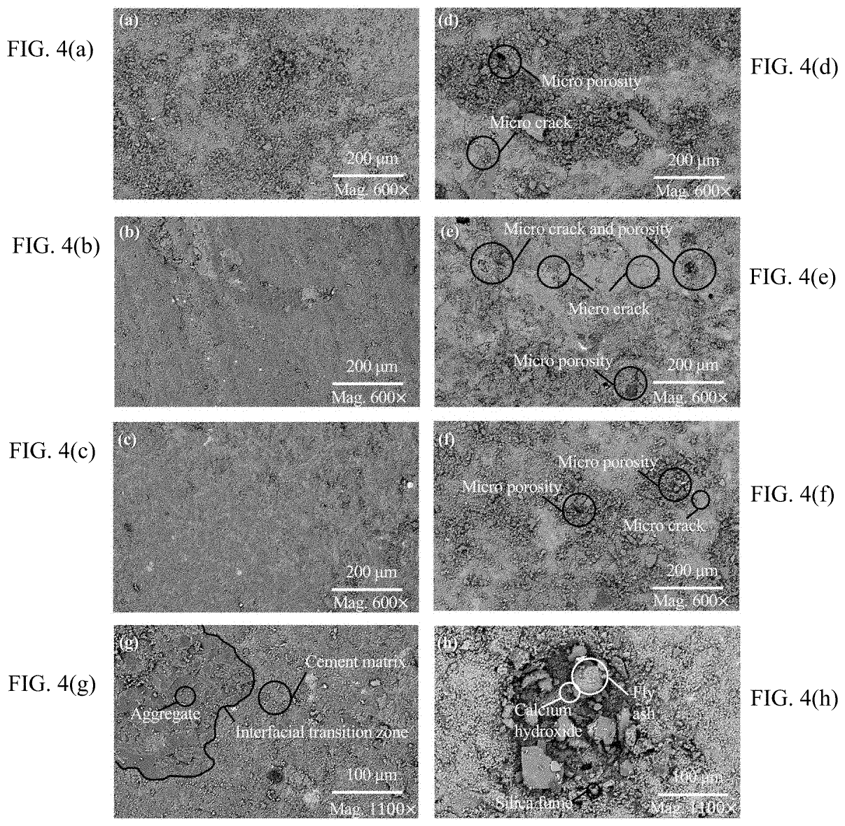

To reveal the microstructural variations and microscale deterioration phenomena of concrete, FIGS. 4(a)-4(h) depicts morphological characteristics with varying UEO contents. In the concrete samples, typical hydration products, including hexagonal calcium hydroxide (CH), needle-like ettringite (Aft), and calcium silica hydrate (C—S—H) gel, can be observed. In SEM images, fewer micro porosities and cracks were observed in concrete admixed with 2% UEO contents than those of the control samples without UEO at 600× magnification (FIGS. 4(a), 4(b), and 4(c)). These defects generated a loose microstructure on the surface of samples at 600× magnification (FIGS. 4(d), 4(e) and 4(f)). Moreover, compared to concrete without UEO, the crack width and porosity size were relatively small in concrete admixed with the proper amount of UEO. These features of the concrete led to the formation of dense microstructure and ITZ at 1100× magnification (FIG. 4(g)). The beneficial effects on the microstructure can be ascribable to the mixture of water, UEO and superplasticizer. Such mixtures decrease the surface tension of capillary pores in concrete, leading to reduced shrinkage, crack mitigation, and dense microstructure in concrete. The refined microstructure of concrete is an essential reason for the increase in the concrete's compressive strength. In high strength concrete with a low water to cementitious materials ratio, the microstructure becomes close-packed, because more cement particles complete the subsequent hydration than in normal strength concrete. In the case of the concrete samples with SCMs, the SEM image reiterated that secondary hydration products between calcium hydroxide and SCMs were bounded at the surface of fly ash at 1100× magnification (FIG. 4(h)). The pozzolanic reactions between calcium hydroxide and SCMs transformed separate portlandite crystals in the vicinity of aggregates into connected phases. Furthermore, the presence of SCMs led to the filling of the excessive pores within the cement hydration products (FIG. 4(h)), improving the mechanical properties of the concrete. These SEM observations provide a morphological illustration of the enhancement in the compressive strength of concrete. Since the SEM results indicate that the addition of treated UEO aided in the densification of the concrete microstructure, it is expected that the durability performance of such green concrete will be improved.

Taken together, the present disclosure provides a means for easily recycling UEO while at the same time produce concrete with improved compressive strength, as compared with those without the incorporation of UEO therein.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of the present disclosure.

What is claimed is:

1. A method for recycling used engine oil (UEO) comprising:
(a) mixing the UEO, a superplasticizer, and water to give a suspension;
(b) mixing aggregates, ordinary Portland cement (OPC), fly ash, silicate fume, and the water to give a first mixture;
(c) adding the suspension of step (a) to the first mixture of step (b) to give a second mixture; and
(d) molding and curing the second mixture of step (c) into a concrete;
wherein, in the second mixture,
the UEO is present in about 1-5% by weight of total cementitious material;
the superplasticizer is present in about 0.1-5% by weight of total cementitious material;
the OPC, the fly ash, and the silicate fume are respectively present in a ratio of 70:25:5 and take about 10-30% by weight of total cementitious material; and
the water is present in about 20-60% by weight total cementitious material.

2. The method of claim 1, wherein the superplasticizer has a hydrophilic-lipophilic balance (HLB) value between 13.6 and 17.

3. The method of claim 2, wherein the superplasticizer is selected from the group consisting of a sulfonated naphthalene formaldehyde condensate, a sulfonated melamine formaldehyde condensate, an acetone formaldehyde condensate and polycarboxylated ethers.

4. The method of claim 3, wherein the superplasticizer is the sulfonated naphthalene formaldehyde condensate.

5. The method of claim 1, wherein in step (a), the suspension is stirred at a speed of 900 rpm for 30 min.

6. The method of claim 5, wherein in step (b), the aggregates comprise coarse aggregates and fine aggregates, respectively, about 20 mm and 10 mm in diameter.

7. The method of claim 6, wherein the coarse aggregates and the fine aggregates are present in the ratio of 1:1.6 by weight in the aggregates.

8. The method of claim 5, wherein in step (b), the OPC, the fly ash, and the silicate fume are present in the ratio of 70:20:5 by weight in the first mixture.

9. The method of claim 8, wherein the UEO and the SP are respectively present in about 1%-5% and 0.1%-5%, respectively, by weight of total cementitious material in the second mixture.
